(19) United States
(12) Patent Application Publication
(10) Pub. No.: US 2006/0097069 A1
(43) Pub. Date: May 11, 2006

(54) Method in conjunction with a spraying apparatus, and spraying apparatus

(76) Inventor: Goran Sundholm, Tuusula (FI)

Correspondence Address: LADAS & PARRY, 26 WEST 61ST STREET, NEW YORK, NY, 10023, US

(21) Appl. No.: 10/531,770

(22) PCT Filed: Nov. 17, 2003
(86) PCT No.: PCT/FI03/00874

§ 371 Date: Oct. 24, 2005

(30) Foreign Application Priority Data
Nov. 18, 2002 (FI) 20022045

(51) Int. Cl. B05B 9/00

(52) U.S. Cl. 239/127; 169/13

(57) ABSTRACT

A method for use in conjunction with a spraying apparatus, especially a fire extinguishing apparatus, said apparatus comprising a source of a medium pump means and means for passing at least a proportion of the medium to at least one nozzle (4). Some of the medium which is not passed to the nozzle is re-circulated back to the suction side of the pump means (3) when necessary and, at least when necessary, at least some of the medium being re-circulated is passed into a discharge pipe (15) before the pump means (3). The invention also relates to an apparatus.

### BACKGROUND OF THE INVENTION

The present invention relates to a method as defined in the preamble of claim 1 for use in conjunction with a spraying apparatus, especially a fire extinguishing apparatus, said apparatus comprising a source of a medium, a pump means and means for passing at least a proportion of the medium to at least one nozzle.

The invention also relates to an apparatus as defined in the preamble of claim 9 for use in conjunction with a spraying apparatus, especially a fire extinguishing apparatus, said apparatus comprising a source of a medium, a pump means and means for conducting at least some of the medium to at least one nozzle.

In prior art, fire extinguishing systems based on water mist are known in which typically at least one high-pressure constant-volume pump, especially a piston pump is used. When such fire extinguishing systems are activated, typically only some of the spray nozzles are triggered. However, the pump unit pumps a constant volume of extinguishing medium into at least one pipeline leading to the nozzle heads. The extra amount of extinguishing medium has typically been re-circulated. The systems typically use an intermediate tank, a so-called break tank of a fairly large capacity between the source of extinguishing medium, such as a water supply pipe, and the pump, and the re-circulated extinguishing medium is returned into the break tank. Especially in the case of high pressure pumps, the extinguishing medium becomes heated during the pumping process, so the use of a break tank prevents excessive heating of the extinguishing medium, overheating being detrimental to the pumps and seals. The returned extinguishing medium stays in the break tank long enough to be cooled down before being circulated by the pump either further to the nozzles or again via re-circulation into the break tank.

However, there has arisen a need, especially where the space available to the system is limited, to achieve a spraying system in which a constant-volume pump, such as a piston pump, can be utilized without a break tank.

### BRIEF DESCRIPTION OF THE INVENTION

The object of the present invention is to achieve a completely new type of solution that will make it easy to implement re-circulation without complex arrangements in conjunction with a piston pump without a break tank.

The method of the invention is mainly characterized in that at least some of the medium which is not passed to the nozzle is re-circulated back to the suction side of the pump means when necessary and that, at least when necessary, at least some of the medium being re-circulated is passed into a discharge pipe before the pump means.

The method of the invention is additionally characterized by what is presented in claims 2-8.

The apparatus of the invention is characterized in that the apparatus comprises means for re-circulating at least some of the medium from the pressure side of the pump means to the suction side of the pump means when necessary, and that the apparatus comprises means for passing at least some of the medium being circulated into a discharge pipe at least when necessary.

The apparatus of the invention is additionally characterized by what is disclosed in claims 10-16.

The solution of the invention provides numerous significant advantages. In a typical fire extinguishing situation, it is very rare that the capacity of the entire fire extinguishing system is utilized at the same time. Typically, only some of the nozzles in the system are activated. This is true particularly in the case of small fires. In such cases, at least a proportion, typically a large proportion of the extinguishing medium being pumped can be circulated and returned to the suction side of the pump means. According to the invention, the temperature of the medium being pumped can be easily influenced by discharging at least some of the medium being circulated if its temperature has reached a set value. By using a throttle element in conjunction with the discharge pipe, the rate of flow of medium passed into the discharge pipe can be advantageously controlled. By using a temperature-controlled valve element, the function of the invention is accomplished in an advantageous manner. According to the invention, almost all of the water being pumped can be effectively utilized, thus avoiding discharges of extra medium from the system, e.g. into a drain. According to the invention, the medium can be re-circulated directly into the pump supply pipe. In this way, the use of an intermediate tank is avoided and a significant saving in space is achieved. In the method and apparatus of the invention, the temperature of the medium being pumped can be effectively reduced by a simple arrangement. The method and apparatus are particularly advantageous when used in conjunction with water-based extinguishing mediums, especially when a mist of extinguishing medium is sprayed at a high pressure.

### BRIEF DESCRIPTION OF THE DRAWINGS

In the following, the invention will be described in detail by the aid of an example with reference to the attached drawing, wherein

FIG. 1 presents a diagram representing an apparatus according to the invention, and

FIG. 2 presents a diagram representing another embodiment of the apparatus of the invention.

### DETAILED DESCRIPTION OF THE INVENTION

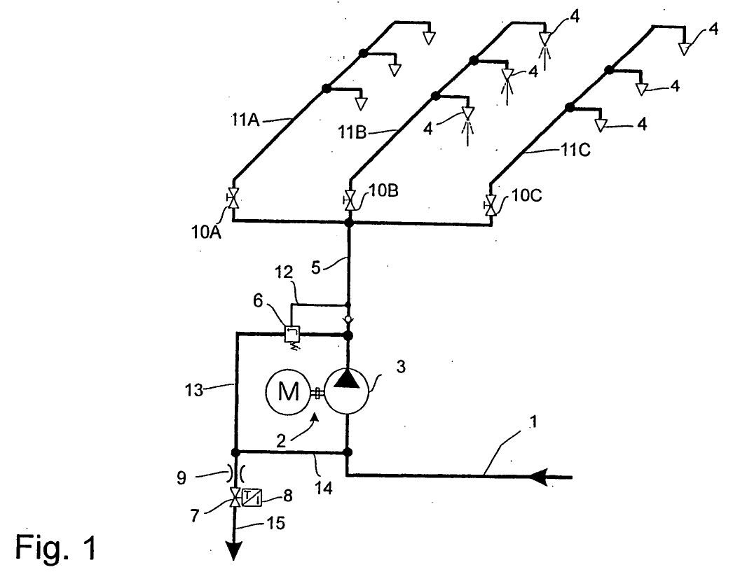

FIG. 1 presents an arrangement according to the invention in conjunction with a spraying apparatus, especially a fire extinguishing apparatus. The system comprises a source 1 of a medium, such as a water pipeline, from which, when the system is activated and after the pump unit 2 has been started up, said medium is supplied to a pump 3, which feeds it through a pipeline 5 to a nozzle 4. Typically, only some of the nozzles are activated to produce a spray of extinguishing medium. However, the pump is rated to deliver extinguishing medium to all the nozzles.

When necessary, at least some of the extinguishing medium which is not passed to the nozzle 4 is re-circulated to the suction side of the pump 3, typically through a pressure valve 6 or equivalent. The pressure valve 6 is opened when the pressure in the pipeline 5 exceeds a set value, whereupon the medium can flow via the route 12, 13, 14 to the suction side of the pump 3. The medium typically becomes heated during the pumping, so when re-circulated, the temperature of the medium may rise considerably. Connected to the medium re-circulation path 13, 14 is a discharge pipe 15 at a point between the pressure valve 6 and the suction side of the pump 3, and the discharge pipe is provided with a valve element 7. The valve element 7 comprises means 8 for opening at least the valve element 7 when necessary, when the temperature of the medium has reached the set value. The discharge pipe 15 is preferably provided with a throttle element 9, which limits the flow from the re-circulation path 13, 14 into the discharge pipe 15.

According to an embodiment, after the valve element 7 has been opened, only e.g. about 10 percent of the medium being re-circulated is passed into the discharge pipe 15 while the rest returns to the suction side of the pump, where the medium to be re-circulated is mixed with typically cooler medium obtained from the source 1.

Thus, by using the arrangement of the invention, surprisingly a system can be achieved in which the use of a so-called break tank is avoided. In addition, typically only a small percentage of the medium being re-circulated is passed into the discharge pipe.

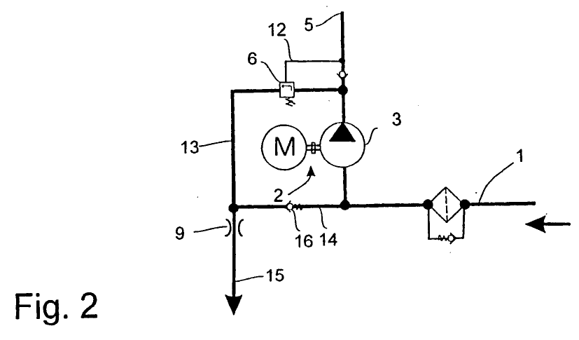

In the figure, the extinguishing system is typically divided into zones, and the admission of extinguishing medium into different zones is regulated e.g. by means of zone valves 10A, 10B, 10C. In the figure, only the middle zone has been activated, in which situation zone valve 10B admits the extinguishing medium to the nozzles. From the zone valves, feed pipes 11A, 11B, 11C lead to the nozzles of each zone. The nozzles 4 may be arranged in spraying heads comprising several nozzles. The spraying heads 4 may be sprinkler-type heads, in which case they comprise triggering devices, or they may be spraying heads without triggering devices. When the amount of liquid to be sprayed is small, a large proportion of the liquid quantity fed by the pump returns back to the suction side of the pump 3. The pressure of the extinguishing medium is at least partially converted to heat due to friction and other factors, thus increasing the temperature of the extinguishing medium. From the return pipe 5, at least a proportion of the liquid can be passed either directly to the pump 3 or into the discharge pipe 15. In a typical fire situation, for example only about ⅓ of the yield of the pump is passed to the nozzles 4, while up to ⅔ is consumed in heating the liquid. In the embodiment in FIG. 2, an alternative solution is presented. In this case, no valve element is needed to control the admission into the discharge pipe of extinguishing medium to be re-circulated and passed into the discharge pipe. The discharge pipe 15 is provided with a throttle element 9, which limits the flow from the re-circulation path 13, 14 into the discharge pipe. According to this embodiment, at least a proportion of the medium to be re-circulated is passed into the discharge pipe. According to an embodiment, a typical proportion may be e.g. 5-10% of the liquid flow to be re-circulated. However, this typically depends on the practical application, e.g. on the allowed temperatures and other parameters of the system. In this embodiment, a check valve 16 is provided in the re-circulation path 13, 14 between the discharge pipe and the pump 3 to prevent liquid flow from the liquid source 1, such as a water pipeline, directly into the discharge pipe 15.

As stated above, the invention relates to a method for use in conjunction with a spraying apparatus, especially a fire extinguishing apparatus, said apparatus comprising a source of a medium, a pump means and means for passing at least a proportion of the medium to at least one nozzle 4. In the method, that part of the medium which is not passed to the nozzle is re-circulated when necessary back to the suction side of the pump means 3, and at least part of the medium to be re-circulated is passed into the discharge pipe 15 before the pump means 3 at least when necessary. According to the method, the medium being pumped is kept at a temperature such that it does not at least exceed a set value. In the method, the flow into the discharge pipe 15 is preferably restricted. At least part of the medium to be re-circulated is passed into the discharge pipe 15 if the temperature of the medium reaches the set value. In an embodiment of the method, the passage into the discharge pipe 15 is opened and/or closed by means of a valve element 7 controlled on the basis of the temperature of the medium. The flow rate of the extinguishing medium re-circulated is reduced when the flow rate of the extinguishing medium supplied to the nozzles 4 is increased. The flow rate of the extinguishing medium to be re-circulated is increased when the flow rate of the extinguishing medium supplied to the nozzles 4 is reduced. According to an embodiment, the medium is a water-based liquid. According to an embodiment, the medium is typically circulated at a high pressure. The pressure in the piping is typically over 1 bar, preferably over 10 bar, most preferably over 30 bar. The maximum pressure is typically 300 bar, preferably 200 bar, most preferably about 140 bar.

An apparatus in conjunction with a spraying system, especially a fire extinguishing system, said apparatus comprising a source of a medium, a pump means and means for passing at least part of the medium to at least one nozzle 4. The apparatus comprises means for re-circulating at least part of the medium from the pressure side of the pump means to the suction side of the pump means when necessary, and the apparatus further comprises means for passing at least part of the medium being circulated into a discharge pipe 15 at least when necessary so that the temperature of the medium being pumped can not rise beyond a given value. The pump means 3 is constant-volume pump, especially piston pump. In the embodiment presented in FIG. 1, the apparatus comprises a valve element 7 for opening the passage into the discharge pipe 15. In an embodiment, the discharge pipe is provided with a throttle element 9. The pump 2 is typically a high pressure pump. The apparatus comprises a passage 13, 14 from the pressure side of the pump means 3 to its suction side, said passage being provided with a pressure valve 6. In an embodiment, the apparatus comprises means 8 for opening and/or closing the valve element 7 on the basis of the temperature of the medium. In an embodiment, the liquid flow passage 14 is provided with a check valve.16 to prevent the admission of the medium being pumped from the suction side of the pump directly into the discharge pipe 15.

The pump 3 is typically a constant-volume pump, especially a high-pressure piston pump, which pumps the extinguishing medium into the piping system 5 leading to the nozzles. The pump is opened by a drive means, such as a motor. The motor and the pump means form a pump unit 2.

It is obvious to the person skilled in the art that the invention is not limited to the example described above, but that it may be varied within the scope of the claims presented below. The features described in the description and mentioned together with each other may also be independent features.

1. Method for use in conjunction with a spraying apparatus, especially a fire: extinguishing apparatus, said apparatus comprising a source of a medium, a pump means and means for passing at least a proportion of the medium to at least one nozzle (4), characterized in that at least some of the medium which is not passed to the nozzle is re-circulated back to the suction side of the pump means (3) when necessary and that, at least when necessary, at least some of the medium being re-circulated is passed into a discharge pipe (15) before the pump means (3).

2. Method according to claim 1, characterized in that the flow into the discharge pipe (15) is restricted.

3. Method according to claim 1, characterized in that at least some of the medium being re-circulated is passed into the dis-charge pipe (15) if the temperature of the medium reaches a set value.

4. Method according to claim 1, characterized in that the passage into the discharge pipe (15) is opened and/or closed by means of a valve element (7) controlled on the basis of the temperature of the medium.

5. Method according to claim 1, characterized in that the flow rate of the medium being re-circulated is reduced when the flow rate of the extinguishing medium supplied to the nozzles (4) is increased.

6. Method according to claim 1, characterized in that the flow rate of the medium being re-circulated is increased when the flow rate of the extinguishing medium supplied to the nozzles (4) is reduced.

7. Method according to claim 1, characterized in that the medium is a water-based liquid.

8. Method according to claim 1, characterized in that, in the method, the medium is circulated at a high pressure.

9. Apparatus for use in conjunction with a spraying apparatus, especially a fire extinguishing apparatus, said apparatus comprising a source of a medium, a pump means and means for conducting at least some of the medium to at least one nozzle (4), characterized in that the apparatus comprises means for re-circulating at least some of the medium from the pressure side of the pump means (3) to the suction side of the pump means when necessary, and that the apparatus comprises means for passing at least some of the medium being circulated into a discharge pipe (15) at least when necessary.

10. Apparatus according to claim 9, characterized in that the pump means (3) is a constant-volume pump, especially a piston pump.

11. Apparatus according to claim 9, characterized in that the apparatus comprises a passage (13,14) from the pressure side of the pump means (3) to its suction side, said passage being provided with a pressure valve (6).

12. Apparatus according to claim 9, characterized in that the apparatus comprises a valve element (7) for opening passage into the discharge pipe (15).

13. Apparatus according to claim 9, character-ized in that the apparatus comprises means (8) for opening and/or closing the valve element (7) on the basis of the temperature of the medium.

14. Apparatus according to claim 9, characterized in that the pump means (3) is a high pressure pump.

15. Apparatus according to claim 9, characterized in that the discharge pipe (15) is provided with a throttle element (9).

16. Apparatus according to claim 9, character-ized in that the liquid flow passage (14) is provided with a second check valve (16) to prevent the admission of the medium being pumped from the suction side of the pump directly into the discharge pipe (15).
